(19) United States
(12) Patent Application Publication
(10) Pub. No.: US 2015/0215662 A1
(43) Pub. Date: Jul. 30, 2015

(54) BROADCASTING TRANSMISSION APPARATUS AND METHOD THEREOF FOR SIMULCAST BROADCASTING

(71) Applicant: Electronics and Telecommunications Research Institute, Daejeon (KR)

(72) Inventors: Min Su SHIN, Daejeon (KR); Deock Gil OH, Daejeon (KR)

(73) Assignee: Electronics and Telecommunications Research Institute, Daejeon (KR)

(21) Appl. No.: 14/251,129

(22) Filed: Apr. 11, 2014

(30) Foreign Application Priority Data
Jan. 29, 2014 (KR) 10-2014-0011082

(51) Int. Cl. H04N 21/266; H04N 21/2365; H04N 21/2383; H04N 21/61

(52) U.S. Cl. CPC H04N 21/26603; H04N 21/6143; H04N 21/2365; H04N 21/2383

(57) ABSTRACT

Disclosed is a broadcasting transmission apparatus for simulcast broadcasting, including: a first stream generating unit configured to generate a first video stream by encoding video data; a second stream generating unit configured to generate a second video stream by encoding the video data; a PMT generating unit configured to generate a program map table (PMT) including a first descriptor that describes whether one or more programs included in the first video stream and the second video stream each are simulcast broadcasting targets and a second descriptor that describes video qualities of the one or more programs; a multiplexing unit configured to generate a first multiplexed stream and a second multiplexed stream by multiplexing each of the first stream and the second stream, and the PMT; a modulation unit configured to modulate the first multiplexed stream and the second multiplexed stream; and a transmission unit configured to transmit the modulated first and second multiplexed streams.

### CROSS-REFERENCE TO RELATED APPLICATIONS

This application claims priority to and the benefit of Korean Patent Application No. 10-2014-0011082 filed in the Korean Intellectual Property Office on Jan. 29, 2014 the entire contents of which are incorporated herein by reference.

### TECHNICAL FIELD

The present invention relates to a broadcasting transmission apparatus and a method for simulcast broadcasting.

### BACKGROUND ART

In a satellite broadcasting system, a plurality of broadcasting streams is multiplexed and transmitted. The satellite broadcasting system uses program specific information (PSI) based on an MPEG-2 system standard (ISO/IEC 13818-1) so as for a broadcasting subscriber to select and receive a desired broadcasting program in the multiplexed broadcasting stream and uses service information (SI) of a DVB standard (ETSI EN 300 468) in order to provide information associated with a service or an event in addition to multiplexed information.

A program association table (PAT) included in the PSI includes No. of the program included in the multiplexed stream and mapping information of a packet identifier (PID) of a program map table (PMT) including information on the corresponding program. The PMT generally includes a number of a specific program, and a service type of the corresponding program and PID information of elementary streams such as video/audio/data constituting the program.

At present, since the PMT defined in the MPEG-2 system standard has only information on one program number, the PMT has only independent information on each program and does not describe a correlation with other programs. Such a scheme may operate without a problem when respective programs are independently selected and processed without a correlation with each other. However, when a channel adaptive service is intended to be provided, which can automatically switch the program of the same content to a program having optimal quality according to a channel state of each receiver (ex., an SNR value, etc.) under a simulcast broadcasting environment that can transmit programs having the same content with different qualities, information on programs having a plurality of layered qualities cannot be transmitted only by information included in a general PMT.

### SUMMARY OF THE INVENTION

The present invention has been made in an effort to provide a broadcasting transmission apparatus and method for simulcast broadcasting that can transmit information on programs having a plurality of layered qualities.

Technical objects of the present invention are not limited to the aforementioned technical objects and other technical objects which are not mentioned will be apparently appreciated by those skilled in the art from the following description.

An exemplary embodiment of the present invention provides a broadcasting transmission apparatus for simulcast broadcasting, including: a first stream generating unit configured to generate a first video stream by encoding video data; a second stream generating unit configured to generate a second video stream by encoding the video data; a PMT generating unit configured to generate a program map table (PMT) including a first descriptor that describes whether one or more programs included in the first video stream and the second video stream each are simulcast broadcasting targets and a second descriptor that describes video qualities of the one or more programs; a multiplexing unit configured to generate a first multiplexed stream and a second multiplexed stream by multiplexing each of the first stream and the second stream, and the PMT; a modulation unit configured to modulate the first multiplexed stream and the second multiplexed stream; and a transmission unit configured to transmit the modulated first and second multiplexed streams.

The PMT generating unit may generate the PMT for each of one or more programs.

The first descriptor may include 2-bit target identification information for describing whether the one or more programs each are the simulcast broadcasting targets.

When the target identification information has a value ‘01’, it may be identified that one or more programs are not the simulcast broadcasting targets and when the target identification information has a value ‘10’, it may be identified that one or more programs are the simulcast broadcasting targets.

The second descriptor may include 3-bit quality identification information for describing the image qualities of the one or more programs.

The second descriptor may further include route identification information for describing transmission network information regarding the first multiplexed stream and the second multiplexed stream.

The first video stream may be a base layer video stream and the second video stream may be an enhancement layer video stream.

Another exemplary embodiment of the present invention provides a broadcasting transmission method for simulcast broadcasting, including: generating a first video stream and a second video stream by encoding video data; generating a program map table (PMT) including a first descriptor that describes whether one or more programs included in the first video stream and the second video stream each are simulcast broadcasting targets and a second descriptor that describes video qualities of the one or more programs; generating a first multiplexed stream and a second multiplexed stream by multiplexing each of the first video stream and the second video stream, and the PMT; modulating the first multiplexed stream and the second multiplexed stream; and transmitting the first multiplexed stream and the second multiplexed stream.

The modulating of the first multiplexed stream and the second multiplexed stream may include remultiplexing the modulated first and second multiplexed streams.

The modulating of the first multiplexed stream and the second multiplexed stream may include modulating the first and second multiplexed streams by using different modulation methods.

In the generating of a program map table (PMT) including a first descriptor that describes whether one or more respective programs included in the first video stream and the second video stream are simulcast broadcasting targets and a second descriptor that describes video qualities of one or more respective programs, the PMT may be generated for each of one or more programs.

The first descriptor may include 2-bit target identification information for describing whether the one or more programs each are the simulcast broadcasting targets.

The second descriptor may include 3-bit quality identification information for describing the image qualities of the one or more programs.

According to exemplary embodiments of the present invention, a broadcasting transmission apparatus and method for simulcast broadcasting can provide an adaptive broadcasting service depending on channel states of individual receivers by transmitting information on programs having a plurality of layer qualities.

### BRIEF DESCRIPTION OF THE DRAWINGS

FIG. 1 is a block diagram illustrating a broadcasting transmission apparatus for simulcast broadcasting according to an exemplary embodiment of the present invention.

FIGS. 2 to 4 are diagrams for describing an operation of a PMT generating unit of the broadcasting transmission apparatus for simulcast broadcasting according to the exemplary embodiment of the present invention.

FIG. 5 is a flowchart illustrating a broadcasting transmission method for simulcast broadcasting according to an exemplary embodiment of the present invention.

### DETAILED DESCRIPTION

Herein, some exemplary embodiments of the present invention will be described in detail with reference to the exemplary drawings. When reference numerals refer to are assigned to components of each drawing, it is noted that although the same components are illustrated in different drawings, the same components are designated by the same reference numerals as possible. In describing the embodiments of the present invention, when it is determined that the detailed description of the known configuration or function related to the present invention interrupts understanding the exemplary embodiment, the detailed description thereof will be omitted.

In describing constituent elements of the exemplary embodiment of the present invention, terms such as first, second, A, B, (a), and (b) may be used. The terms are only used to distinguish a constituent element from another constituent element, but a nature or an order of the constituent element is not limited by the terms. If it is not contrarily defined, all terms used herein including technological or scientific terms have the same meaning as those generally understood by a person with ordinary skill in the art. Terms which are defined in a generally used dictionary should be interpreted to have the same meaning as a meaning that matches a contextual meaning of the art but are not interpreted as an idealistic or excessively formal meaning if it is not clearly defined in the present application.

The present invention relates to a broadcasting transmission apparatus and method for simulcast broadcasting. ‘Simulcast broadcasting’ described in the specification may mean broadcasting programs having the same content with different video qualities. For example, the simulcast broadcasting may mean transmitting both standard definition (SD) and high definition (HD) programs with respect to one broadcasting program. The simulcast broadcasting method may be used for an adaptive service for remedying a disadvantage of satellite broadcasting which is weak to a rainy environment. A receiving device selects an HD program in the case of no rain and selects and decodes an SD program in the case of a rain through an adaptive service, and as a result, a broadcasting service may not be interrupted but maintained even in the case of the rain.

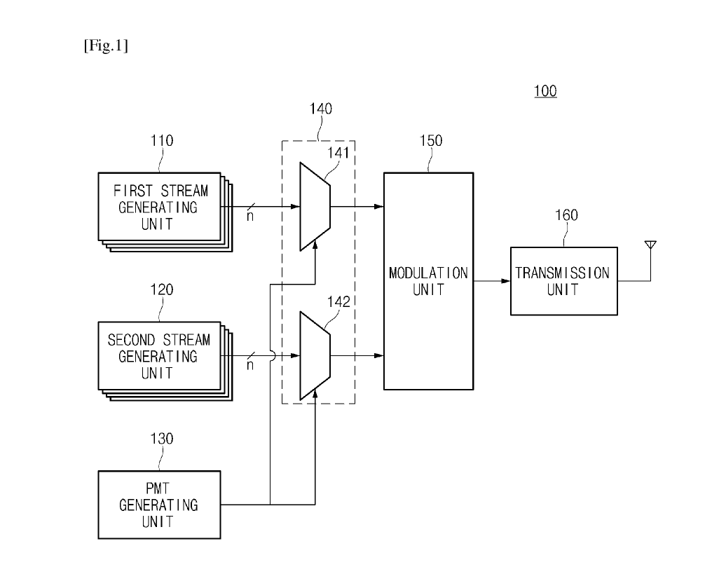

FIG. 1 is a block diagram illustrating a broadcasting transmission apparatus for simulcast broadcasting according to an exemplary embodiment of the present invention.

Referring to FIG. 1, the broadcasting transmission apparatus 100 for simulcast broadcasting according to the exemplary embodiment of the present invention may include a first stream generating unit 110, a second stream generating unit 120, a PMT generating unit 130, a multiplexing unit 140, a modulation unit 150, and a transmission unit 160.

The first stream generating unit 110 may generate a first video stream by encoding video data of a base layer for at least one program.

The second stream generating unit 120 may generate a second video stream by encoding video data of an enhancement layer for at least one program.

The first video stream and the second video stream may include at least one program and are different from each other in video quality and may include the same program.

For example, the base layer may mean a video having a standard definition (SD) resolution and the enhancement layer may mean a video having a high definition (HD) resolution, but they are not limited thereto and it should be understood that the meanings of the base layer and the enhancement layer are relative to each other.

The PMT generating unit 130 may generate a program map table (PMT). The PMT generating unit 130 may generate the PMT for each of the first video stream of the base layer and the second video stream of the enhancement layer. The PMT generating unit 130 may generate the PMT for each of at least one program included in the first video stream and the second video stream.

The PMT may include a first descriptor that describes whether one or more programs included in the first video stream and the second video stream each are simulcast broadcasting targets and a second descriptor that describes video qualities of the one or more programs.

The first descriptor may include 2-bit target identification information for describing whether one or more programs each are the simulcast broadcasting targets. The second descriptor may include 3-bit quality identification information for describing the video qualities of the one or more programs. The second descriptor may further include route identification information for describing transmission network information regarding the first video stream and the second video stream.

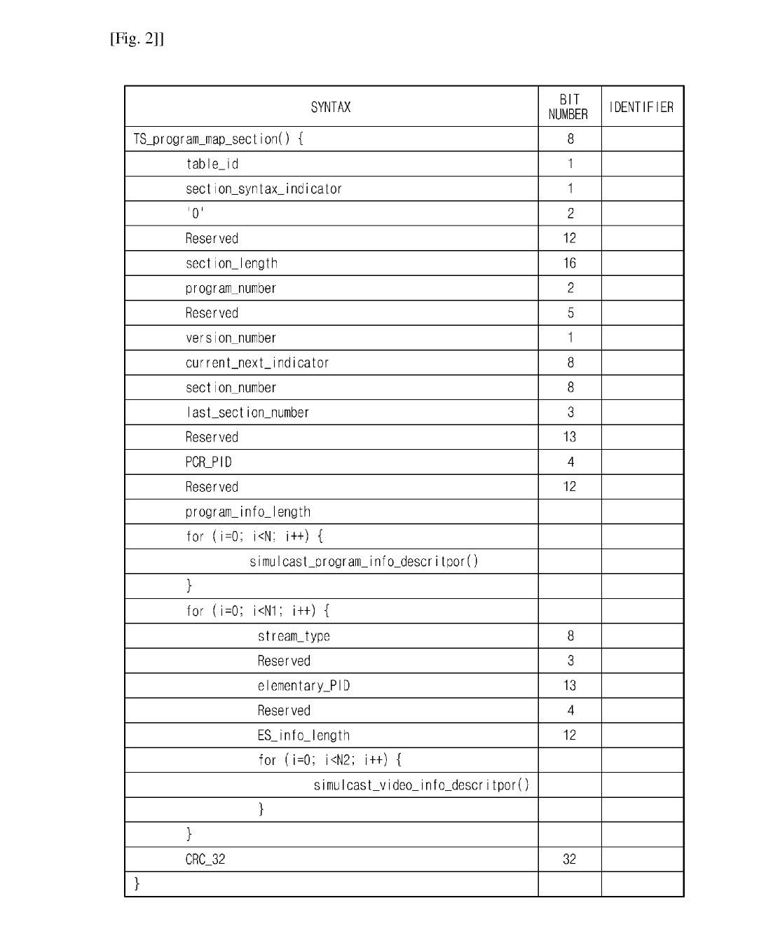

General fields, and the first descriptor and the second descriptor included in the PMT will be described below in more detail with reference to FIGS. 2 to 4.

The multiplexing unit 140 may include a first multiplexer 141 and a second multiplexer 142. The first multiplexer 141 multiplexes the first video stream and the PMT for the first video stream to generate a first multiplexed stream. The second multiplexer 142 multiplexes the second video stream and the PMT for the second video stream to generate a second multiplexed stream.

The modulation unit 150 may modulate each of the first multiplexed stream and a second multiplexed stream. For example, the modulation unit 150 may modulate the first multiplexed stream and the second multiplexed stream by using different modulation methods and forward error correction (FEC) methods. For example, the modulation unit 150 may modulate the first multiplexed stream in a QPSK 3/4 method and modulate the second multiplexed stream in an 8PSK 3/4 method, and the present invention is not limited thereto. Further, the modulation unit 150, for example, may modulate the first multiplexed stream and the second multiplexed stream, and remultiplex the streams to transmit the remultiplexed streams to the transmission unit 160.

The transmission unit 160 may transmit the modulated first and second multiplexed streams.

As described above, the PMT generating unit 130 of the broadcasting transmission apparatus 100 for simulcast broadcasting according to the exemplary embodiment of the present invention may generate the PMT including the first descriptor and the second descriptor. Accordingly, the broadcasting transmission apparatus 100 for simulcast broadcasting may provide whether the one or more programs transmitted through the first and second video streams each are the simulcast broadcasting targets and the video quality information of each program to broadcasting receiving devices. Therefore, the broadcasting receiving devices select the first or second video stream according to a channel state (for example, an intensity of a received signal, and the like) to demultiplex and decode the selected video stream. Consequently, the broadcasting transmission apparatus 100 for simulcast broadcasting according to the exemplary embodiment of the present invention transmits the information on the programs having the plurality of layer qualities to enable channel adaptive simulcast broadcasting.

FIGS. 2 to 4 are diagrams for describing an operation of a PMT generating unit of the broadcasting transmission apparatus for simulcast broadcasting according to the exemplary embodiment of the present invention.

First, referring to FIG. 2, the PMT may be implemented through a syntax constituted by various fields.

table_id is constituted by a 8-bit field and illustrates a table to which a corresponding section belongs. A value of table_id is determined in ISO and ETSI.

section_syntax_indicator as a 1-bit field indicates compatibility with PSI of an MPEG-2 system standard and is used with being fixed to ‘1’.

section_length is a 12-bit field and is used to indicate the length of the corresponding section. Since the length of the section is limited to 1,024 bytes, upper 2 bits are fixed to “00”. The length of the section indicates the size of data constituting a section shown continuously subsequently to the field of section_length.

program_number as a 16-bit field is a number for identifying programs in the transmitted stream.

version_number is used as a 5-bit field and indicates version information for program guide. A corresponding content of program guide or service information is changed with time due to an attribute thereof. That is, since a content of another program needs to be guided when a predetermined time elapses as the program is broadcasted, new-version program information needs to be transmitted. That is, version_number is used in order to notify that the new-version program information is different from the previously transmitted service information or program guide information. The version_number is transmitted while sequentially increasing a section version_number of table_id which is previously used.

current_next_indicator is constituted by a 1-bit field and indicates whether the transmitted content is a content to be applied immediately at present or a content to be applied immediately next. This provides a method in which a receiver considers information to be changed after a little time elapses to cope with the changed information. When a field value of current_next_indicator is ‘1’, a current PMT is valid and a version number value of the PMT indicates a version value of the valid PMT. When the field value of current_next_indicator is ‘0’, a PMT to be transmitted next is valid and a version number value of the PMT to be transmitted next indicates the version value of the valid PMT.

section_number indicates a number of the section with a 8-bit field and the receiver may rearrange an order of received tables by using the section number.

last_section_number indicates a section-number of a last section of a present table and is constituted by the 8-bit field.

PCR_PID is constituted by a 13-bit field and indicates a PID value of a TS packet having a valid PCR used in a program indicated by a program number, and when a predetermined is not associated with the PCR, all of PCR_PID values need to be 1 bit.

program_info_length is constituted by the 12-bit field and indicates the number of bytes of a descriptor shown just subsequently to program_info_length.

simulcast_program_info_descriptor (hereinafter, referred to as a ‘first descriptor’) may be defined as a descriptor that describes whether the one or more programs included in the first and second video streams each are the simulcast broadcasting targets.

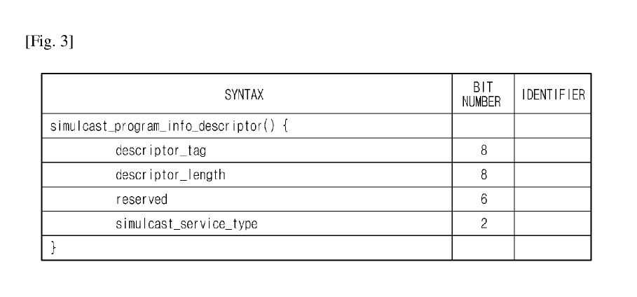

Referring to FIGS. 2 and 3, the first descriptor may be constituted by a syntax including 2-bit target identification information (simulcast_service_type) for describing whether the one or more programs each are the simulcast broadcasting targets.

For example, when the target identification information (simulcast_service_type) has a value ‘01’, it may be identified that a target program is not the simulcast broadcasting target and when the target identification information (simulcast_service_type) has a value ‘10’, it may be identified that the target program is the simulcast broadcasting target, and the present invention is not limited thereto. That is, for example, the broadcasting receiving device may identify whether the program corresponding to program_number is the simulcast broadcasting target through the target identification information (simulcast_service_type) by referring to the received PMT.

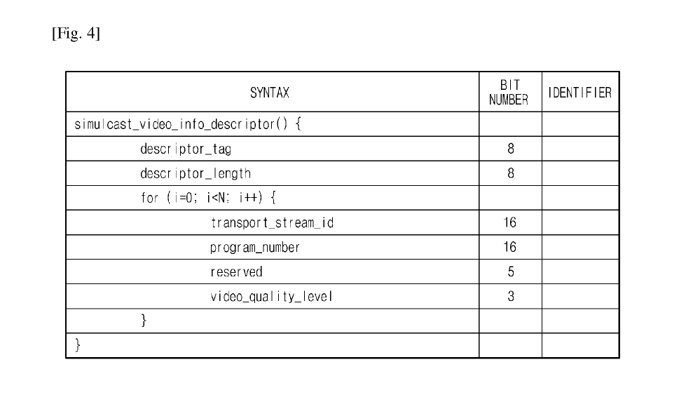

Referring to FIGS. 2 and 4, simulcast_video_info_descriptor (hereinafter, referred to as a ‘second descriptor’) may be defined as a descriptor that describes the video qualities of the one or more programs included in the first and second video streams.

The second descriptor may be constituted by a syntax including 3-bit quality identification information (video_quality_level) for describing the video qualities of the one or more programs.

For example, when the quality identification information (video_quality_level) has a value ‘001’, it may be identified that the target program has the image quality of the base layer and when the quality identification information (video_quality_level) has a value ‘010’, it may be identified that the target program has the image quality of the enhancement layer, and the present invention is not limited thereto. Accordingly, the quality identification information (video_quality_level) may have the value ‘001’ in the PMT for the first video stream and the value ‘010’ in the PMT for the second video stream.

The second descriptor may be constituted by a syntax including 16-bit route identification information (transport_stream_id) for describing transmission network information for the first video stream and the second video stream. For example, the first video stream and the second video stream may be transmitted to the broadcasting receiving device through different transmission networks and the broadcasting receiving device may identify a transmission network through which each video stream including the program corresponding to program_number is received through the route identification information (transport_stream_id).

That is, for example, the PMT for the first video stream may include both the second descriptor for the first video stream and the second descriptor for the second video stream, and as a result, route information of the second video stream simultaneously broadcasted as the first video stream may be verified.

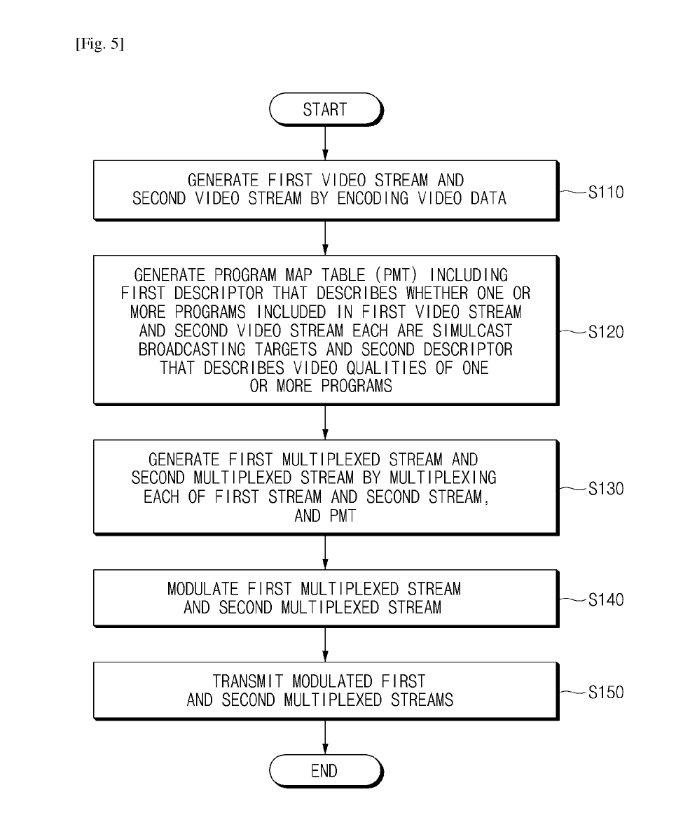

FIG. 5 is a flowchart illustrating a broadcasting transmission method for simulcast broadcasting according to an exemplary embodiment of the present invention.

Referring to FIG. 5, the broadcasting transmission method for simulcast broadcasting according to the exemplary embodiment of the present invention may include generating a first video stream and a second video stream by encoding image data (S110), generating a PMT including a first descriptor that describes whether one or more programs included in the first video stream and the second video stream are simulcast broadcasting targets and a second descriptor that describes image qualities of the one or more programs (S120), generating a first multiplexed stream and a second multiplexed stream by multiplexing each of the first video stream and the second video stream with the PMT (S130), modulating the first multiplexed stream and the second multiplexed stream (S140), and transmitting the modulated first and second multiplexed streams (S150).

Hereinafter, steps S110 to S150 above will be described in detail with reference to FIG. 1.

First, in step S110, the first stream generating unit 110 may generate a first video stream by encoding image data of the base layer for at least one program. The second stream generating unit 120 may generate a second video stream by encoding image data of an enhancement layer for at least one program. The first video stream and the second video stream may include at least one program and are only different from each other in image quality and may include the same program.

In step S120, the PMT generating unit 130 may generate a program map table (PMT). The PMT generating unit 130 may generate the PMT for each of at least one program included in the first video stream and the second video stream. The PMT may include a first descriptor that describes whether one or more programs included in the first video stream and the second video stream each are simulcast broadcasting targets and a second descriptor that describes image qualities of the one or more programs. The first descriptor may include 2-bit target identification information for describing whether the one or more programs each are the simulcast broadcasting targets. The second descriptor may include 3-bit quality identification information for describing the image qualities of the one or more programs. Further, the second descriptor may include route identification information for describing transmission network information regarding the first video stream and the second video stream.

In step S130, the first multiplexer 141 multiplexes the first video stream and the PMT for the first video stream to generate a first multiplexed stream. The second multiplexer 142 multiplexes the second video stream and the PMT for the second video stream to generate a second multiplexed stream.

In step S140, the modulation unit 150 may separately modulate the first multiplexed stream and a second multiplexed stream. For example, the modulation unit 150 may modulate the first multiplexed stream and the second multiplexed stream by using different modulation methods and forward error correction (FEC) methods. The modulation unit 150, for example, may modulate the first multiplexed stream and the second multiplexed stream, and remultiplex the streams to transmit the remultiplexed streams to the transmission unit 160.

In step S150, the transmission unit 160 may transmit the modulated first and second multiplexed streams to the broadcasting receiving device.

As described above, the broadcasting transmission method for simulcast broadcasting according to the exemplary embodiment of the present invention may generate the PMT including the first descriptor that describes whether the one or more programs included in the first video stream and the second video stream each are the simulcast broadcasting targets and the second descriptor that describes the video qualities of the one or more programs, and multiplex the generated PMT with the first video stream and the second video stream and transmit the multiplexed PMT, and the first and second video streams.

Accordingly, the broadcasting transmission method for simulcast broadcasting may provide whether the one or more programs transmitted through the first and second video streams each are the simulcast broadcasting targets and the image quality information of each program to broadcasting receiving devices. Therefore, the broadcasting receiving devices select the first or second video stream according to a channel state (for example, an intensity of a received signal, and the like) to demultiplex and decode the selected stream. For example, the broadcasting receiving device selects an HD program in the case of no rain and selects an SD program in the case of a rain to demultiplex and decode the selected program. Consequently, the broadcasting transmission apparatus 100 for simulcast broadcasting according to the exemplary embodiment of the present invention transmits the information on the programs having the plurality of layer qualities to enable adaptive simulcast broadcasting of selecting a program optimal for a channel state.

Steps of the method or algorithm described in association with the exemplary embodiments disclosed in the specification may be directly implemented by a hardware module, a software module or a combination thereof executed by a processor. The software module may reside in a RAM, a flash memory, a ROM, an EPROM, an EEPROM, a register, a hard disk, an attachable disk, a CD-ROM, or any other type storage medium which is known in the art. An exemplary storage medium may be coupled to the processor, and the processor may read information from the storage medium and write information in the storage medium. As another method, the storage medium may be a type which is integrated with the processor. The processor and the storage medium may reside in an on-demand integrated circuit (ASIC). The ASIC may reside in a user terminal. As another method, the processor and the storage medium may reside in the user terminal as individual components.

It will be appreciated that various embodiments of the present invention have been described herein for purposes of illustration, and that various modifications, changes, substitutions may be made by those skilled in the art without departing from the essential characteristic of the present invention. Accordingly, the various exemplary embodiments disclosed herein are intended not to limit but to describe the technical spirit of the present invention and the true scope of the spirit of the present invention is not limited to the exemplary embodiments. The scope of the present invention should be interpreted by the appended claims and the technical spirits in the equivalent range theretoare analyzed to be embraced by the right scope of the present invention.

What is claimed is:

1. A broadcasting transmission apparatus for simulcast broadcasting, the apparatus comprising:
a first stream generating unit configured to generate a first video stream by encoding video data;
a second stream generating unit configured to generate a second video stream by encoding the video data;
a PMT generating unit configured to generate a program map table (PMT) including a first descriptor that describes whether one or more programs included in the first video stream and the second video stream each are simulcast broadcasting targets and a second descriptor that describes video qualities of the one or more programs;
a multiplexing unit configured to generate a first multiplexed stream and a second multiplexed stream by multiplexing each of the first stream and the second stream, and the PMT;
a modulation unit configured to modulate the first multiplexed stream and the second multiplexed stream; and
a transmission unit configured to transmit the modulated first and second multiplexed streams.

2. The apparatus of claim 1, wherein the PMT generating unit generates the PMT for each of one or more programs.

3. The apparatus of claim 2, wherein the first descriptor includes 2-bit target identification information for describing whether the one or more programs each are the simulcast broadcasting targets.

4. The apparatus of claim 3, wherein when the target identification information has a value ‘01’, it is identified that one or more programs are not the simulcast broadcasting targets and when the target identification information has a value ‘10’, it is identified that one or more programs are the simulcast broadcasting targets.

5. The method of claim 2, wherein the second descriptor includes 3-bit quality identification information for describing the image qualities of the one or more programs.

6. The apparatus of claim 5, wherein the second descriptor further includes route identification information for describing transmission network information regarding the first multiplexed stream and the second multiplexed stream.

7. The apparatus of claim 1, wherein the first video stream is a base layer video stream and the second video stream is an enhancement layer video stream.

8. A broadcasting transmission method for simulcast broadcasting, the method comprising:
generating a first video stream and a second video stream by encoding video data;
generating a program map table (PMT) including a first descriptor that describes whether one or more programs included in the first video stream and the second video stream each are simulcast broadcasting targets and a second descriptor that describes video qualities of the one or more programs;
generating a first multiplexed stream and a second multiplexed stream by multiplexing each of the first video stream and the second video stream, and the PMT;
modulating the first multiplexed stream and the second multiplexed stream; and
transmitting the first multiplexed stream and the second multiplexed stream.

9. The method of claim 8, wherein the modulating of the first multiplexed stream and the second multiplexed stream includes remultiplexing the modulated first and second multiplexed streams.

10. The method of claim 9, wherein the modulating of the first multiplexed stream and the second multiplexed stream includes modulating the first and second multiplexed streams by using different modulation methods.

11. The method of claim 8, wherein in the generating of a program map table (PMT) including a first descriptor that describes whether one or more programs included in the first video stream and the second video stream are simulcast broadcasting targets and a second descriptor that describes video qualities of one or more respective programs, the PMT is generated for each of one or more programs.

12. The method of claim 11, wherein the first descriptor includes 2-bit target identification information for describing whether the one or more programs each are the simulcast broadcasting targets.

13. The method of claim 11, wherein the second descriptor includes 3-bit quality identification information for describing the image qualities of the one or more programs.
